(19) United States
(12) Patent Application Publication
(10) Pub. No.: US 2026/0025242 A1
(43) Pub. Date: Jan. 22, 2026

(54) GROUP FREQUENCY HOPPING OF AMBIENT INTERNET OF THINGS (AIOT) DEVICES

(71) Applicant: Lenovo (Singapore) Pte Limited, Singapore (SG)

(72) Inventors: Abir BEN HADJ FREDJ, Frankfurt am main (DE); Karthikeyan Ganesan, Nauheim (DE); Ali Ramadan Ali, Kraiburg am Inn (DE)

(21) Appl. No.: 18/777,463

(22) Filed: Jul. 18, 2024

(51) Int. Cl. H04L 5/00; H04W 72/0446; H04W 72/0453

(52) U.S. Cl. CPC H04L 5/0012; H04W 72/0446; H04W 72/0453

(57) ABSTRACT

Various aspects of the present disclosure relate to group frequency hopping for ambient Internet of Things (AIoT) devices. For example, a non-orthogonal multiple access mechanism for AIoT devices enabling a group of devices to simultaneously and non-orthogonally transmit different transport blocks (TBs) to a receiver device (a base station, UE, and so on). The group of UEs may perform group frequency hopping to transmit data blocks at different frequencies and time slots. A receiver device may then detect the transmissions (e.g., superimposed signals) using multi-user detection techniques.

### TECHNICAL FIELD

The present disclosure relates to wireless communications, and more specifically to group frequency hopping of Internet of Things (IoT) devices, such as ambient IoT (AIoT) devices.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Ambient power-enabled devices, such as ambient Internet of Things (IoT) devices, or AIoT devices, include battery-less devices that have limited storage capabilities (e.g., they store a limited amount of energy using capacitors) or other capability restrictions. These restricted devices may store energy by harvesting energy from the environment of the IoT device, such as via radio waves, light, heat, motion, and other energy/power sources available to the IoT device.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that facilitate group frequency hopping of IoT devices, such as ambient-powered IoT devices.

Some implementations of the method and apparatuses described herein may further include a UE for wireless communication, comprising at least one memory and at least one processor coupled with the at least one memory and configured to cause the UE to transmit, simultaneously with a group of UEs that includes the UE, data blocks over an initial carrier frequency and perform group frequency hopping by transmitting, simultaneously with the group of UEs, data blocks over a shifted carrier frequency.

In some implementations of the method and apparatuses described herein, the at least one processor is configured to cause the UE to transmit the data over the initial carrier frequency at an initial time slot and perform the group frequency hopping at a next time slot after the initial time slot.

In some implementations of the method and apparatuses described herein, the shifted carrier frequency is shifted based on one or more carrier frequency shifts configured for the group of UEs.

In some implementations of the method and apparatuses described herein, the group of UEs includes passive AIoT devices, semi-passive AIoT devices, or active AIoT devices.

In some implementations of the method and apparatuses described herein, the UE is an AIoT device.

In some implementations of the method and apparatuses described herein, the data blocks transmitted over the initial carrier frequency are the same as the data blocks transmitted over the shifted carrier frequency.

In some implementations of the method and apparatuses described herein, the data blocks transmitted over the initial carrier frequency are different than the data blocks transmitted over the shifted carrier frequency.

In some implementations of the method and apparatuses described herein, the one or more carrier frequency shifts are selected to reduce transmission interference between the group of UEs and another group of UEs.

In some implementations of the method and apparatuses described herein, the UE is a passive AIoT device or a semi-passive AIoT device, and wherein the at least one processor is further configured to cause the UE to receive a carrier wave from a reader device and transmit the data blocks over the initial carrier frequency and the shifted carrier frequency via backscatter transmissions responsive to the received carrier wave.

In some implementations of the method and apparatuses described herein, the data blocks comprise constellation points, including: quadrature amplitude modulation (QAM), quadrature phase shift keying (QPSK), or phase shift keying (PSK).

In some implementations of the method and apparatuses described herein, the data blocks are codewords drawn from codebooks configured for AIoT devices.

Some implementations of the method and apparatuses described herein may further include a processor for wireless communication, comprising at least one controller coupled with at least one memory and configured to cause the processor to transmit, simultaneously with a group of UEs that includes the processor, data blocks over an initial carrier frequency and perform group frequency hopping by transmitting, simultaneously with the group of UEs, data blocks over a shifted carrier frequency.

Some implementations of the method and apparatuses described herein may further include a network entity for wireless communication, comprising at least one memory and at least one processor coupled with the at least one memory and configured to cause the network entity to determine a configuration that identifies one or more carrier frequency shifts of carrier frequencies used by a group of UEs for simultaneous transmission of data blocks and transmit the determined configuration to the group of UEs.

In some implementations of the method and apparatuses described herein, the at least one processor is further configured to cause the network entity to receive superposed transmissions from the group of UEs and detect and decode the received superposed transmissions via multi-user detection algorithms.

In some implementations of the method and apparatuses described herein, the superposed transmissions include signatures for each UE of the group of UEs, and wherein the at least one processor is further configured to re-synchronize transmissions received from each UE of the group of UEs using the signatures.

In some implementations of the method and apparatuses described herein, the at least one processor is further configured to cause the network entity to estimate timing errors between each UE of the group of UEs using the signatures for each UE.

In some implementations of the method and apparatuses described herein, the at least one processor is further configured to cause the network entity to trigger the group of UEs to transmit the signatures for each UE to the network entity.

In some implementations of the method and apparatuses described herein, the at least one processor is configured to cause the network entity to identify the group of UEs via a group identifier for the group of UEs.

In some implementations of the method and apparatuses described herein, the network entity is a receiver device and the group of UEs includes passive AIoT devices, semi-passive AIoT devices, or active AIoT devices.

Some implementations of the method and apparatuses described herein may further include a method performed by a network entity, the method comprising determining a configuration that identifies one or more carrier frequency shifts of carrier frequencies used by a group of UEs for simultaneous transmission of data blocks and transmitting the determined configuration to the group of UEs.

### BRIEF DESCRIPTION OF THE DRAWINGS

FIG. 1 illustrates an example of a wireless communications system in accordance with aspects of the present disclosure.

FIG. 2 illustrates an example topology of an AIoT device and receiver device in accordance with aspects of the present disclosure.

FIG. 3 illustrates an example diagram depicting group frequency hopping for a group of AIoT devices in accordance with aspects of the present disclosure.

FIG. 4A illustrates an example diagram of the transmission of superimposed signals by AIoT devices over time-frequency resources in in accordance with aspects of the present disclosure.

FIG. 4B illustrates an example of a synchronization error impact in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

A wireless communication system may include one or more AIoT devices, which may be a passive-IoT device or a passive radio frequency identification (RFID) tag (e.g., sticker, tag, badge, patch, or the like) that supports one or more functionalities at lower cost and maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device). The AIoT may perform one or more operations (e.g., transmission, reception, via backscattering) using the stored harvested energy. For example, the AIoT device may be a passive RFID tag equipped on an object or other device enabling for tracking of a location of the object or the other device using stored harvested energy.

An AIoT device may be classified according to one or more categories. A first category AIoT device may lack both energy harvesting capabilities and communication capabilities. As such, the first category AIoT device may be considered a passive device and be exclusively capable of performing backscattering operations (e.g., backscattering transmissions). A second category AIoT device may support energy harvesting capabilities but lack communication capabilities. As such, the second category AIoT device may be considered a semi-passive device and be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may be considered an active device and support both energy harvesting and communication capabilities. In this example, the third category AIoT device may be equipped with an active radio frequency circuitry to support active communication (e.g., transmission, reception of signals).

In some cases, the wireless communications system may implement various topologies and deployment scenarios, such as one example topology in which a NE (e.g., a base station or other network entity) functions as a reader and a source of a carrier wave (e.g., for exciting an AIoT device to perform backscattering), another example topology in which the NE functions as the reader and a different device (e.g., a UE or other intermediate node) functions as the source of the carrier wave (e.g., an emitter node), another example topology in which the NE controls operations and other network entities (e.g., nodes) function as readers and/or carrier wave sources, and so on.

In some cases, transmissions emitted from multiple AIoT devices (e.g., from a group of devices) can lead to destructive interference. Wireless communications systems may employ different mechanisms (e.g., anti-collision algorithms or compressed sensing-based schemes, such as sparse code multiple access (SCMA) and orthogonal frequency-division multiplexing (OFDM)) to handle such issues. However, these mechanisms may introduce unusable complexities for low power consumption devices, such as AIoT devices.

The present disclosure introduces a non-orthogonal multiple access mechanism for AIoT devices, enabling a group of devices to simultaneously and non-orthogonally transmit different transport blocks (TBs) to a receiver device (a base station, UE, and so on). For example, the group of UEs performs group frequency hopping to transmit data blocks at different frequencies and time slots. A receiver device may then detect the transmissions (e.g., superimposed signals) using multi-user detection techniques.

Thus, the utilization of group frequency hopping for a group of AIoT devices enables the devices to employ a non-orthogonal multiple access scheme that is less complex and/or consumes less power than other schemes (e.g., SCMA, OFDM, and so on). These devices, which can have an ultra-low complexity and/or ultra-low power consumption, may then be deployed as a group in a location and transmit information to an associated receiver device without realizing destructive interference or other issues during simultaneous transmissions to the receiver device.

Aspects of the present disclosure are described in the context of a wireless communications system.

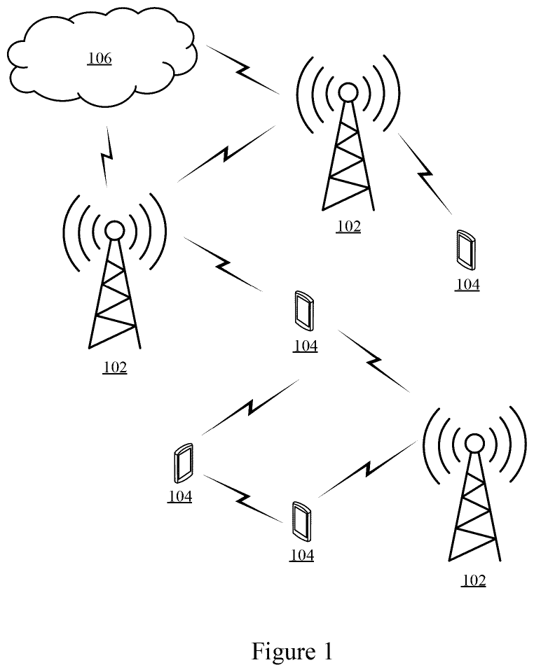

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be example of th UE 104), such as ambient IoT devices. As described herein, an AIoT device may be associated with a low complexity profile (e.g., low power consumption, less capabilities). Unlike other IoT devices defined by 3^{rd} Generation Partnership Project (3GPP), ambient power-enabled devices may exclude a universal subscriber identity module (USIM), and thus may lack components (e.g., circuitry) that can apply security to communications to/from the devices and/or perform signal generation and transmissions.

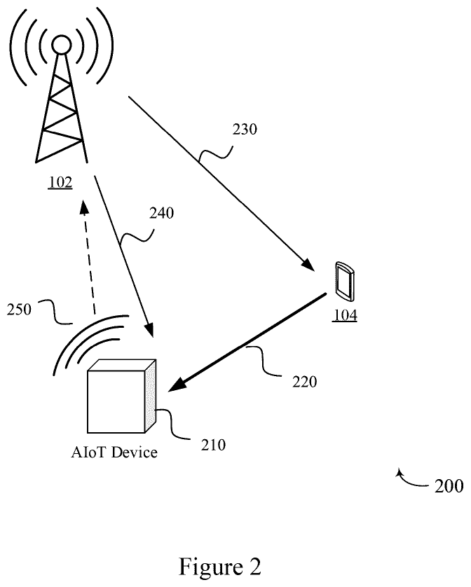

FIG. 2 illustrates an example topology 200 of an AIoT device and receiver device in accordance with aspects of the present disclosure. The topology 200 includes the NE 102 (e.g., a base station), the UE 104 (e.g., acting as an emitter node), and an AIoT device 210. The UE 104 sends carrier waves 220 to the AIoT device 210, which excite the AIoT device 210, enabling or causing the AIoT device 210 to performing backscattering transmissions 250, which are read by the NE 102 (acting as a reader).

While the topology 200 illustrates one deployment of the AIoT device 210, other deployments are possible. For example, a deployment may include the NE 102 acting as the emitter node and the reader (or receiver) node, a deployment may include the UE 104 as the emitter node and the reader (or receiver) node, a deployment may include another NE 102 as an intermediate node (e.g., an emitter node), and so on.

As described herein, the present disclosure enables the non-orthogonal multiple access of several IoT devices (e.g., a group of AIoT devices) using group frequency hopping. The group frequency hopping enables devices of reduced complexity and/or low-energy consumption to share time and frequency resources to simultaneously transmit data blocks.

For example, a group of AIoT devices may be configured by a base station (e.g., the NE 102) to transmit transport blocks over a same or common carrier frequency, apply a pre-configured frequency shift to the common carrier frequency, and transmit the transport blocks (or different TBs) over the shifted carrier frequency. In some cases, the number and value of the frequency shifts may be configured to facilitate in-band or inter-band frequency hopping. Further, the data blocks may be encoded using orthogonal codes.

In some embodiments, a group of AIoT devices is configured with several frequency shifts. The devices may be configured to perform group carrier frequency hopping at different time slots, and simultaneously transmit data blocks at each time-frequency resource (RE). A receiver device, such as a base station, may receive the superposed signals from the various AIoT devices, and detect/decode the signals using multi-user detection algorithms. Example detection algorithms include a message passing algorithm (MPA), approximate message passing (AMP), and so on.

For example, at a time slot t_{c}, a group of AIoT devices transmit data blocks simultaneously over a same carrier frequency ƒ_{c}. At a time slot (t_{c}+τ), the same group of AIoT devices shift the carrier frequency to (ƒ_{c}+ω) and simultaneously transmit the same data blocks or different data blocks (e.g., next data blocks). In some cases, the pattern of the frequency shift/hopping may be determined based on several metrics, such as metrics based on channel conditions, frequency bands, interference reduction, and so on.

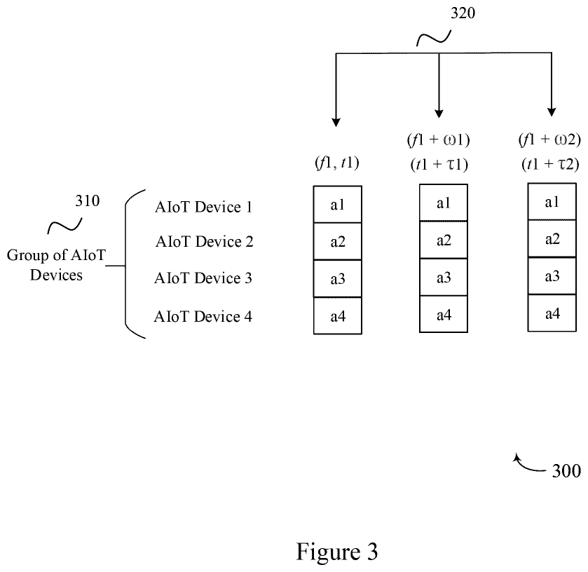

FIG. 3 illustrates an example diagram 300 depicting group frequency hopping for a group of AIoT devices in accordance with aspects of the present disclosure. Each pre-defined group of AIoT devices 310 transmits data blocks over multiple carrier frequencies 320. For example, the group of AIoT devices 310 transmits data blocks over a first carrier frequency ƒ_{c} at time slot t_{c}. At a next or different time slot (t_{c}+τ), the devices 310 shift the frequency to (ƒ_{c}+ω) and simultaneously transmit the same data blocks or next data blocks.

For example, the group of AIoT devices 310 transmit first data blocks (e.g., first symbols) by modulating a locally generated carrier wave at frequency ƒ_{c} at time slot t_{c}, perform group frequency hopping by shifting the frequency by a pre-configured frequency shift ω, and transmit second data blocks (e.g., second symbols) at carrier frequency (ƒ_{c}+ω) at time slot (t_{c}+τ).

Each AIoT device (e.g., IoT device 1, IoT device 2, IoT device 3, IoT device 4) transmits their respective symbols (e.g., a₁, a₂, a₃, a₁) over an initial carrier frequency (ƒ₁) at an initial time slot (t₁), over a first shifted carrier frequency (ƒ₁+ω₁) at a next time slot (t₁+τ₁), over a second shifted carrier frequency (ƒ₁+ω₂) at a next time slot (t₂+τ₂), and so on. Thus, in some cases, such as for active AIoT devices, the AIoT device may transmit a first symbol/codeword over a first carrier frequency at a certain time slot and the same or a different symbol/codeword over a shifted carrier frequency.

In some cases, such as for passive and/or semi-passive AIoT devices, a continuous carrier wave transmitted by an associated reader/base station is backscattered by different AIoT devices within a certain range. For example, the reader may transmit a first carrier wave with carrier frequency ƒ_{c} at time slot t_{c} and then transmit another continuous carrier wave with carrier frequency (ƒ_{c}+ω) at time slot (t_{c}+τ). In some cases, the reader may perform such a scheme when symbol-level synchronization between the different AIoT devices is maintained through physical random access channel (PRACH) or downlink (DL) synchronization signal blocks (SSBs).

In some embodiments, a base station (e.g., the NE 102) may configure a group of AIoT devices, or multiple different groups of devices) to deploy or apply a certain frequency hopping pattern, such as where carrier frequencies are shifted in a baseband or in an RF domain. The base station may configure, randomly and/or dynamically, each group of AIoT devices based on different parameters, such as channel conditions, frequency bands, inter-group interference, and/or various combinations thereof.

In some embodiments, the symbols represent different codewords carved out from a pre-configured codebook or a repetition of different constellation symbols representing the same data. For example, different data blocks may be repetitions of symbols carved out from basic constellations, such as QAM, QPSK, PSK, and so on. As another example, the data blocks may be encoded using pseudo-random codes or different codebooks designed for ambient IoT devices.

In some cases, each AIoT device transmits symbols that are different or repetitions of constellation's symbols (e.g., QAM, QPSK) or carved out from different codebooks. Each AIoT device may include a dedicated codebook (e.g., a sparse codebook). For example, if AIoT device j intends to transmit bⱼ bits, an encoder maps the bⱼ bits of a transport block to a series of codewords.

In some cases, each codeword mⱼ may belong to a codebook based on a phase rotation, complex conjugate, layer power offset, and/or dimensional permutation of a mother constellation (e.g., a QAM constellation, a golden angle modulation (GAM) constellation, and so on). In some cases, each codeword mⱼ may be a constellation point (e.g., BPSK, QAM, and so on), where the same codeword is transmitted over one or more resource elements (frequency shifts and time slots).

In some cases, each IoT device may include a different sparse codebook and each column of the codebook represents a codeword, where incoming bits are mapped into codewords and same or different codewords are transmitted over different resource elements.

In some embodiments, a base station may identify groups of AIoT devices by group identifiers (IDs) assigned to the groups. In some cases, the base station configures each group of AIoT devices with a different or unique frequency hopping pattern to reduce interference between groups of AIoT devices. In some cases, the base station may configure the number of AIoT devices within a group, the associated frequency shifts, and so on, where the group IDs are based on channel conditions, total number of eligible AIoT devices, and so on.

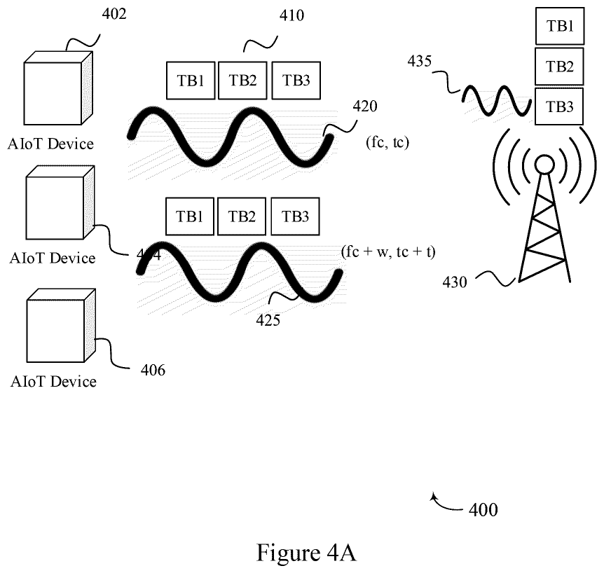

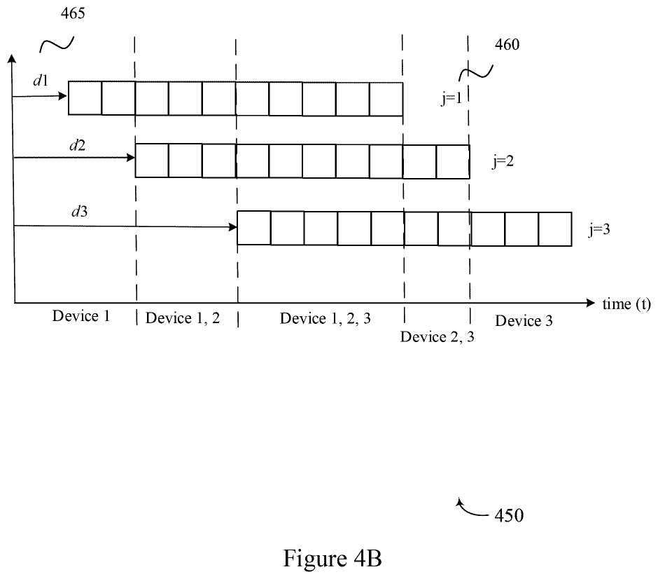

As described herein, in some embodiments, the receiver device employs various detection techniques to detect and decode superimposed signals received from multiple AIoT devices. FIG. 4A illustrates an example diagram 400 of the transmission of superimposed signals by AIoT devices over time-frequency resources in accordance with aspects of the present disclosure.

Three AIoT devices 402, 404, 406 simultaneously transmit data blocks 410 (e.g., TB₁, TB₂, TB₃), resulting in two superimposed signals over two time-frequency resources 420, 425. A base station 430 receives the superimposed signals and detects/decodes data blocks 430 by applying a multi-user algorithm.

In some cases, the multi-user detection algorithm may be an iterative receiver, such as MPA, Max-Log MPA, Log-MPA, or other MPA variants. Further, the base station 430 may determine a-posteriori probabilities based on the received signal and the codebooks of the AIoT devices 402, 404, 406, where a factor graph includes function nodes (e.g., which correspond to number of devices) and variable nodes (correspond to resource elements).

Thus, unlike a compressed-sensing scheme and/or SCMA, the disclosed technology may include the following components and/or benefits: codewords from different devices may be transmitted over continuous carrier wave signals (e.g., generated or backscattered by an AIoT device). Different resource elements may be created by applying frequency shifts of the carrier wave at different time slots, all data types may be transmitted, many different MIPAs may be utilized, different modulation schemes may be performed, symbols may be transmitted over different carrier frequencies, and, with respect to factor graphs, subcarriers may be replaced by carrier frequency and different frequency shifts over which different AIoT devices superpose transmissions.

In some embodiments, the multiple access scheme may utilize symbol-level synchronization between AIoT devices. However, to maintain synchronization between AIoT devices, certain techniques, such as those that expand upon the compressed sensing scheme, may be employed. For example, the base station may receive device signature sequences, and re-synchronize the devices using the signatures.

For example, the base station, receiver device, and/or reader device may trigger transmission of the signatures upon detecting synchronization errors within received signals. As another example, the devices may periodically transmit their signatures to the base station. In some cases, signature sequences may be drawn from a signature pool known to the AIoT devices and the base station, where allocation of signature sequences may be performed in a deterministic or random manner. Example signature sequences include M ASK symbols from {b0, b1}\hat{ }M generated pseudo-randomly and where symbols occur with equal probabilities.

Using the signatures, the base station may estimate the delay for each AIoT device within a group of AIoT devices, and accurately detect/decode data received from the different AIoT devices. FIG. 4B illustrates an example of a synchronization error impact 450 in accordance with aspects of the present disclosure.

Multiple AIoT devices (e.g., j=1, j=2, j=3) of a group of AIoT devices 460 simultaneously transmit data blocks over the same time-frequency resource. Due to the ultra-low complexity and ultra-low power consumption of the group of AIoT devices 460, such as passive or semi-passive devices, synchronization errors may occur, resulting in data from the different AIoT devices being received at the BS/reader with different delays 465 (e.g., time delays of d1, d2, d3, and so on).

For example, the base station may detect the synchronization (or synchronization errors) when the transmissions are received. Due to a large sampling frequency offset (SFO) of ˜105 ppm, the timing error may accumulate by 1 ms every 10 ms for an AIoT device, which is as large as 1 slot of NR. Without perfect synchronization, sampling over received signals may result in inter-symbol interference, which can impact the detection and decoding of the received signal.

Thus, the base station may, upon detection of the error, trigger a re-synchronization of groups of AIoT devices, such as by triggering the transmission of signature sequences known to the base station and transmitters.

In some cases, the group of AIoT devices, such as active devices, may be configured to utilize a certain frequency shift value when transmitting signature sequences to the base station. The group of AIoT devices may periodically transmit the signature sequences using the same frequency shift, and the base station may detect the signature sequences using the compressed-sensing based schemes described herein.

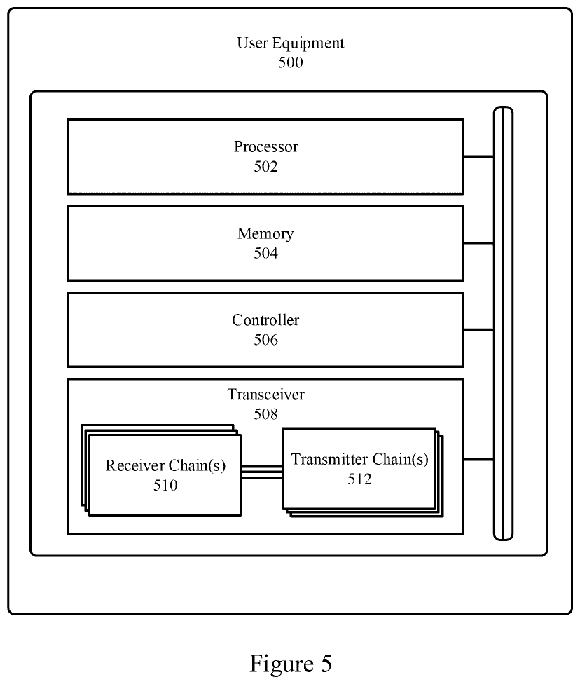

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for transmitting, simultaneously with a group of UEs that includes the processor, data blocks over an initial carrier frequency, and performing group frequency hopping by transmitting, simultaneously with the group of UEs, data blocks over a shifted carrier frequency.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

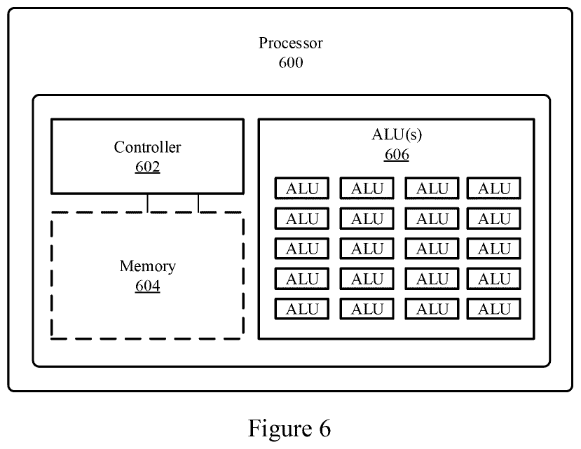

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The UE processor 600 may be configured to support a means for transmitting, simultaneously with a group of UEs that includes the processor, data blocks over an initial carrier frequency, and performing group frequency hopping by transmitting, simultaneously with the group of UEs, data blocks over a shifted carrier frequency.

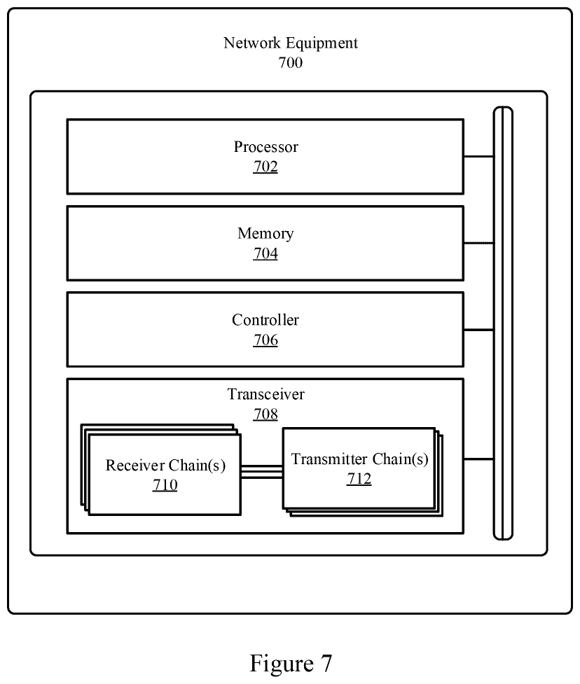

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for determining a configuration that identifies one or more carrier frequency shifts of carrier frequencies used by a group of UEs for simultaneous transmission of data blocks and transmitting the determined configuration to the group of UEs.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

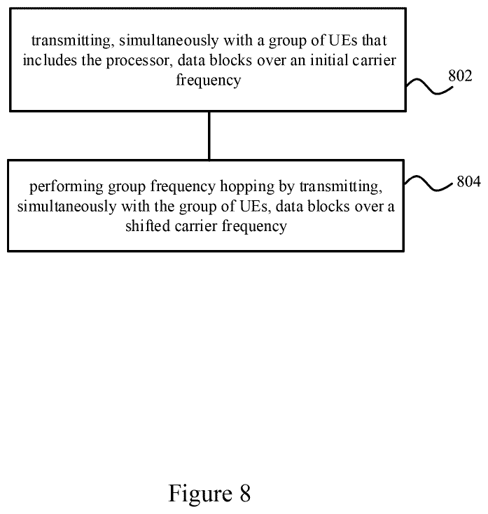

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include transmitting, simultaneously with a group of UEs that includes the processor, data blocks over an initial carrier frequency. The operations of 802 may be performed in accordance with examples as described herein. In some implementations, aspects of the operations of 802 may be performed by a UE as described with reference to FIG. 5.

At 804, the method may include performing group frequency hopping by transmitting, simultaneously with the group of UEs, data blocks over a shifted carrier frequency. The operations of 804 may be performed in accordance with examples as described herein. In some implementations, aspects of the operations of 804 may be performed by a UE as described with reference to FIG. 5.

It should be noted that the method described herein describes a possible implementation, and that the operations and the steps may be rearranged or otherwise modified and that other implementations are possible.

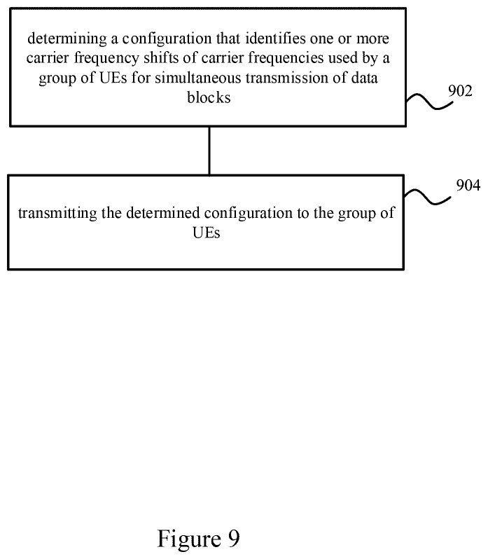

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include determining a configuration that identifies one or more carrier frequency shifts of carrier frequencies used by a group of UEs for simultaneous transmission of data blocks. The operations of 902 may be performed in accordance with examples as described herein. In some implementations, aspects of the operations of 902 may be performed by an NE as described with reference to FIG. 7.

At 904, the method may include transmitting the determined configuration to the group of UEs. The operations of 904 may be performed in accordance with examples as described herein. In some implementations, aspects of the operations of 904 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit, simultaneously with a group of UEs that includes the UE, data blocks over an initial carrier frequency; and
perform group frequency hopping by transmitting, simultaneously with the group of UEs, data blocks over a shifted carrier frequency.

2. The UE of claim 1, wherein the at least one processor is configured to cause the UE to transmit the data over the initial carrier frequency at an initial time slot and perform the group frequency hopping at a next time slot after the initial time slot.

3. The UE of claim 1, wherein the shifted carrier frequency is shifted based on one or more carrier frequency shifts configured for the group of UEs.

4. The UE of claim 1, wherein the group of UEs includes passive ambient Internet of Things (AIoT) devices, semi-passive AIoT devices, or active AIoT devices.

5. The UE of claim 1, wherein the UE is an ambient internet of things (AIoT) device.

6. The UE of claim 1, wherein the data blocks transmitted over the initial carrier frequency are the same as the data blocks transmitted over the shifted carrier frequency.

7. The UE of claim 1, wherein the data blocks transmitted over the initial carrier frequency are different than the data blocks transmitted over the shifted carrier frequency.

8. The UE of claim 1, wherein the one or more carrier frequency shifts are selected to reduce transmission interference between the group of UEs and another group of UEs.

9. The UE of claim 1, wherein the UE is a passive ambient Internet of Things (AIoT) device or a semi-passive AIoT device, and wherein the at least one processor is further configured to cause the UE to:
receive a carrier wave from a reader device; and
transmit the data blocks over the initial carrier frequency and the shifted carrier frequency via backscatter transmissions responsive to the received carrier wave.

10. The UE of claim 1, wherein the data blocks comprise constellation points, including: quadrature amplitude modulation (QAM), quadrature phase shift keying (QPSK), or phase shift keying (PSK).

11. The UE of claim 1, wherein the data blocks are codewords drawn from codebooks configured for ambient Internet of Things (AIoT) devices.

12. A processor for wireless communication, comprising:
at least one controller coupled with at least one memory and configured to cause the processor to:
transmit, simultaneously with a group of user equipment (UEs) that includes the processor, data blocks over an initial carrier frequency; and
perform group frequency hopping by transmitting, simultaneously with the group of UEs, data blocks over a shifted carrier frequency.

13. A network entity for wireless communication, comprising:
at least one memory; and
at least one processor coupled with the at least one memory and configured to cause the network entity to:
determine a configuration that identifies one or more carrier frequency shifts of carrier frequencies used by a group of user equipment (UEs) for simultaneous transmission of data blocks; and
transmit the determined configuration to the group of UEs.

14. The network entity of claim 13, wherein the at least one processor is further configured to cause the network entity to:
receive superposed transmissions from the group of UEs; and
detect and decode the received superposed transmissions via multi-user detection algorithms.

15. The network entity of claim 14, wherein the superposed transmissions include signatures for each UE of the group of UEs, and wherein the at least one processor is further configured to:
re-synchronize transmissions received from each UE of the group of UEs using the signatures.

16. The network entity of claim 15, wherein the at least one processor is further configured to cause the network entity to estimate timing errors between each UE of the group of UEs using the signatures for each UE.

17. The network entity of claim 13, wherein the at least one processor is further configured to cause the network entity to trigger the group of UEs to transmit the signatures for each UE to the network entity.

18. The network entity of claim 13, wherein the at least one processor is configured to cause the network entity to identify the group of UEs via a group identifier for the group of UEs.

19. The network entity of claim 13, wherein the network entity is a receiver device and the group of UEs includes passive ambient Internet of Things (AIoT) devices, semi-passive AIoT devices, or active AIoT devices.

20. A method performed by a network entity, the method comprising:
determining a configuration that identifies one or more carrier frequency shifts of carrier frequencies used by a group of user equipment (UEs) for simultaneous transmission of data blocks; and
transmitting the determined configuration to the group of UEs.
